(19) United States
(12) Patent Application Publication
(10) Pub. No.: US 2006/0050784 A1
(43) Pub. Date: Mar. 9, 2006

(54) Method and device for transcoding images

(76) Inventors: Ville Lappalainen, Tampere (FI); Juha Sarkijarvi, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/533,345

(22) PCT Filed: Nov. 1, 2002
(86) PCT No.: PCT/IB02/04577

§ 371 Date: Apr. 29, 2005

(51) Int. Cl. H04N 11/04; H04B 1/66

(52) U.S. Cl. 375/240.03

(57) ABSTRACT

A method and device for transcoding digital images where at least portions of a first image coded according to a first method is decoded for obtaining first coefficients of a luminance component and chrominance components of the first image, where the chrominance components are subjected to a combined inverse quantization according to the first method and quantization according to a second method. The combined inverse quantization and quantization respectively uses a chrominance quantization matrix and a luminance quantization matrix for obtaining second coefficients for chrominance components of the second image having the same chroma format as the JPEG image. Finally, the first coefficients of the luminance component of the first image and the second coefficients of the chrominance components of the second image are coded for obtaining the second image decodable according to the second method.

### FIELD OF THE INVENTION

The invention generally relates to transcoding of digital images. More specifically, the invention relates to a method and a device for transcoding digital images.

### BACKGROUND OF THE INVENTION

The use of digital media, such as digital images, is becoming more and more widespread. Two important standards for coding digital images including compression of the images are JPEG (Joint Photographic Experts Group) (see e.g. Digital compression and coding of continuous-tone still images, (JPEG), ISO/IEC 10918-1, February 1994)) and MPEG (Moving Picture Expert Group) (see e.g. Generic coding of moving pictures and associated audio information: Video, (MPEG-2), ISO/IEC 1318-2, May 1996)). Since JPEG is used for still images it only reduces the spatial redundancy of the image. MPEG on the other hand, is used for moving pictures which can be viewed as a set of successive images. Thus, MPEG also takes the temporal relation between successive images into account and reduces the temporal redundancy.

The transcoding of JPEG images to MPEG pictures have been addressed in prior art, e.g. in the paper “An efficient JPEG to MPEG-1 transcoding algorithm” by Wu et al in IEEE Transactions on Consumer Electronics Vol. 42, No. 3, August 1996. This paper addresses the difficulty of editing an MPEG-1 coded video sequence due to the fact that successive images of the video sequence are not independent of each other. A method is proposed for editing video sequences where a video sequence is edited where each successive image of the sequence is JPEG coded into a JPEG coded bit stream. The JPEG coded bit stream is then transcoded from JPEG to a MPEG-1 decodable bit stream. Both JPEG and MPEG-1 use the same transform kernel, the 8×8 two-dimensional discrete cosine transform (2D DCT). Thus, in order to speed up the transcoding the JPEG coded bit stream into an MPEG coded bit stream, the conversion is done directly in the DCT-domain. Hence, the time spent in converting back and forth between the transform domain and the spatial domain can be saved.

In spite of the time saved in the above proposed transcoding method of prior art, the complexity of this prior art method will still give rise to a considerable time spent for the transcoding between JPEG and MPEG images, especially in equipment which has low performance. Thus, there is a desire to lower the complexity of the transcoding even further.

The paper “Compressed Domain Transcoding” by Soam Acharya and Brian Smith, IEEE International Conference on Multimedia Computing and Systems, Jun. 28-Jul. 01, 1998, Austin, Tex., discloses a method of transcoding MPEG-1 to Motion_JPEG (MJPEG) in which the inverse scan and scan operations are omitted. This paper does not disclose the reverse transcoding, i.e. from MJPEG to MPEG-1, and only considers grey-scale video.

A problem which arises in the case of the transcoding from JPEG to MPEG is two quantization matrices are used in JPEG whereas only one quantization matrix is used in MPEG.

### SUMMARY OF THE INVENTION

The invention overcomes or alleviates the problem in prior art by means of a method and a device for transcoding digital images.

According to a first aspect of the invention a method is provided for transcoding digital images. According to the method at least portions of a first image coded according to a first method is decoded to obtain first coefficients of a luminance component and chrominance components of the first image coded according to the first method. The first coefficients of the chrominance components of the first image coded according to the first method are then subjected to a combined inverse quantization according to the first method and quantization according to the second method. This combined inverse quantization and quantization is done by means of the chrominance quantization matrix of the first method in the inverse quantization according to the first method and the luminance quantization matrix of the first method in the quantization according to the second method, and quantized second coefficients of chrominance components of at least portions of a second image according to the second method having the same chroma format as the first image coded according to the first method are obtained. The first coefficients of the luminance component of the at least portions of the first image coded according to the first method and the second coefficients of chrominance components of the at least portions of the second image according to the second method are then coded for obtaining at least portions of the second image decodable according to the second method.

The use of the chrominance quantization matrix of the first method in the inverse quantization according to the first method and the luminance quantization matrix of the first method in the quantization according to the second method in the combined inverse quantization and quantization considerably reduces the complexity of the conversion of the first coefficients of the chrominance components of the at least portions of the first image coded according to the first method to the second coefficients of chrominance components of the at least portions of the second image according to the second method. In fact the method according to the invention enables the omitting of the inverse scan and scan operations, as well as the reduction of the complexity as compared to the prior art separate JPEG inverse quantization and MPEG quantization. In terms of inverse quantization and quantization, this is omitted entirely for the luminance component and simplified considerably for the chrominance component. This omission and reduction will enhance the speed of the transcoding of the first image coded according to the first method to the second image according to the second method, which in turn enables a fast display of an transcoded first image on for example a TV-screen by means of an decoder for the second image in a set top box. Furthermore, the transcoded image resulting from the method according to the invention, when it is decoded and presented, does not present any observable reduction in image quality.

Furthermore, the use of the chrominance quantization matrix of the first method and the luminance quantization matrix for the first method in the combined inverse quantization and quantization solves the problem arising when there are two quantization matrices for images coded according to the first method and only one for images according to the second method.

In an embodiment the combined inverse quantization and quantization comprises deriving of each of the second coefficients of chrominance components of the at least portions of the second image according to the second method as the multiplication of a corresponding coefficient of the first coefficients of the chrominance components of the at least portions of the first image coded according to the first method with the quotient between a corresponding element in the chrominance quantization matrix of the first method and a corresponding element in the luminance matrix of the first method.

In addition to the enabling of the omission of the inverse scan and scan operations in prior art methods, this embodiment also results in a considerable reduction of the number of arithmetic operation needed for converting the first coefficients of the chrominance component of the at least portions of the first image to second coefficients of the chrominance component of the at least portions of the second image. Furthermore, also the inverse quantization and quantization of the luminance component is possible to omit.

In a preferred embodiment of the method according to the invention a precomputed set of quotients between each element in the chrominance quantization matrix of the first method and a corresponding element in the luminance quantization matrix of the first method is provided.

This embodiment enables the creation of a look-up table for a fixed-point number representation of the quotients before the actual time-consuming kernel loops, which enables the avoiding of any division operations during the frequently executed kernel loops.

In a further embodiment of the method according to the invention the at least portions of the second image are decodable according to the second method are decoded.

In another embodiment of the method according to the invention the first image coded according to the first method is an JPEG image, and the second image coded according to the second method is an MPEG intra frame.

Furthermore, in one embodiment the first and second coefficients are quantized discrete cosine transform coefficients, the inverse quantization according to the first method is JPEG inverse quantization, the quantization according to the second method is MPEG quantization. The chrominance quantization matrix of the first method is the JPEG chrominance quantization matrix, and the luminance quantization matrix of the first method I the JPEG luminance quantization matrix.

For the purpose of this application the term MPEG should be interpreted to be one of MPEG-1, MPEG-2 and MPEG-4.

The JPEG quantization matrix and the reconstructed DCT coefficients of the JPEG image are reused for the MPEG quantization. Furthermore, a q_scale_type and quantizer_scale_code is selected for MPEG-2 so that a q_scale equal to 16 is obtained and selected. For MPEG-4, parameters vop_quant, dquant, dbquant, and quant_scale for luminance and chrominance are selected so that qantizer_scale equal to 8 is obtained. For MPEG-4 ac_pred_flag is set to 0. Also, the JPEG chrominance matrix is used in the JPEG inverse quantization and the JPEG luminance quantization matrix is used in the MPEG quantization. Thus, by combining the formula for the JPEG inverse quantization and the formula for the MPEG quantization for intra frames and e.g. chroma format 4:2:0, a formula may be derived for the combined JPEG inverse quantization and MPEG quantization. This formula for combined inverse quantization and quantization determines the relationship between the quantized DCT coefficients of the chrominance component of the JPEG image and quantized DCT coefficients of the chrominance component of the MPEG intra frame to be computed. More specifically, each of the quantized DCT coefficients of the chrominance component of the MPEG intra frame to be computed is equal to a corresponding quantized DCT coefficient of the chrominance components of the JPEG image multiplied with the quotient between a corresponding element in the JPEG chrominance quantization matrix and a corresponding element in the JPEG luminance quantization matrix.

The method according to the invention may be used for output of an MPEG-1 intra frame, MPEG-2 intra frame or an MPEG-4 intra frame.

According to another embodiment of the method according to the invention chroma format is 4:2:0 for the JPEG image and for the MPEG intra frame.

According to a second aspect of the invention a device is provided for transcoding digital images. The device comprises a means for decoding of at least portions of a first image coded in accordance with a first method for obtaining first coefficients of a luminance component and chrominance components of the first image coded according to the first method. The device further comprises a means for combined inverse quantization according to the first method and quantization according to a second method of the first coefficients of the chrominance components of the first image coded according to the first method. The means uses a chrominance matrix of the first method for inverse quantization according to the first method and a luminance quantization matrix of the first method for quantization according to the second method, for obtaining second coefficients of chrominance components of at least portions of a second image according to the second method having the same chroma format as the first image coded according to the first method. The means for combined inverse quantization and quantization is operatively connected to the means for decoding. The device also comprises a means for coding of the first coefficients of the luminance component of the at least portions of the first image coded according to the first method and of the second coefficients of chrominance components of the at least portions of the second image according to the second method, for obtaining at least portions of the second image decodable according to the second method. The means for coding is operatively connected to the means for combined inverse quantization and quantization and to the means for coding.

### BRIEF DESCRIPTION OF THE FIGURES

In the following, the present invention is illustrated by way of example and not limitation with reference to the accompanying drawings, in which:

FIG. 1 shows a block diagram of a system in which the invention may be advantageously used;

FIG. 2 shows a flow chart of a prior art method for transcoding a JPEG coded bit stream to a MPEG-1 decodable bit stream;

FIG. 3 shows a general flow chart of the method according to the invention;

FIG. 4 shows a flow chart of an embodiment of the method according to the invention;

FIG. 5 shows a block diagram of an embodiment of the device according to the invention;

FIGS. 6 shows another system for which the invention may be advantageously used;

FIGS. 7 and 8 show flow charts of methods in which the invention may be advantageously used; and

FIG. 9 shows a screen view related to the system shown in FIG. 6 and methods shown in FIGS. 7 and 8.

### DETAILED DESCRIPTION OF THE INVENTION

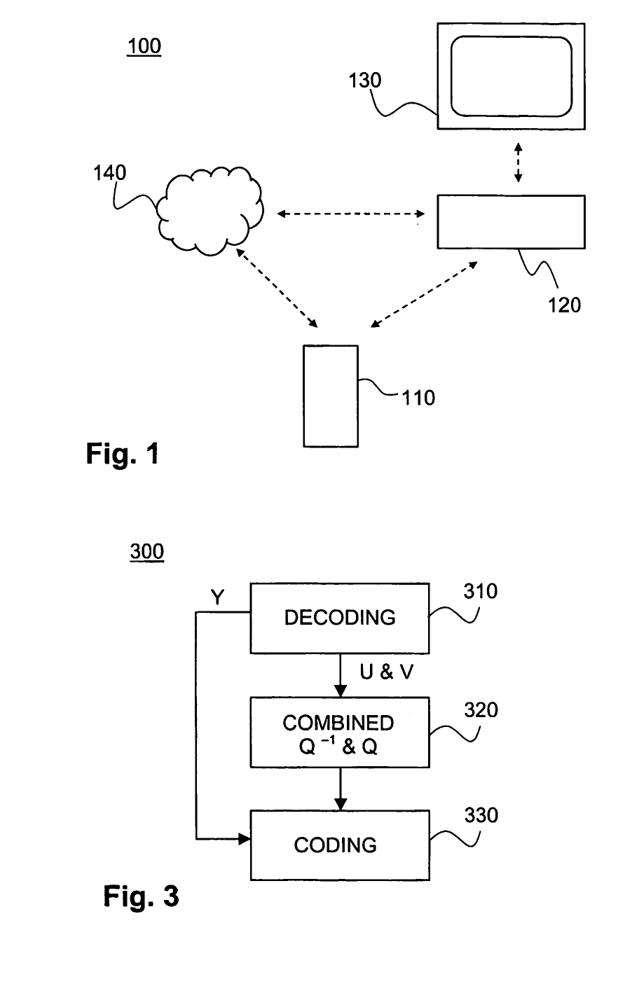

FIG. 1 shows a block diagram of a system 100 in which the invention may be advantageously used. The system 100 comprises a device 110 for storage and transfer of digital images, a set-top box 120, a television screen 130 and a mobile communication system 140. The device 110 may be any device capable of storing and transferring digital images, such as JPEG images, and may also be provided with a camera functionality. For example the device 110 may be a digital camera or a mobile phone provided with a camera functionality, such as the Nokia 7650 mobile phone. The device 110 is able to transfer JPEG images to the set top box 120, such as Nokia Mediamaster 230 S STB, for example by means of a short range radio interface, such as Bluetooth, the mobile communication system 140, wire line connection, or any other present or future transfer means. The transferred JPEG image is then transcoded in accordance with the invention in the set top box 120 into a MPEG decodable intra frame. The MPEG decodable intra frame may then be MPEG decoded and presented on the television screen 130. Other devices for storage and transfer of digital images will be readily apparent to the skilled person within the art. Of course the JPEG image can be stored in the set top box 120 for later transcoding, decoding and presentation, or even better, the transcoded MPEG intra frame can be stored in the set top box 120 for later decoding and presentation on the television screen 130. The set top box 120 is only an example of a device in which the transcoding according to the invention may be applied. Other devices comprising means for performing the transcoding according to the invention will be readily apparent to the skilled person. The transcoding according to the invention is especially advantageous in devices which provides low performance for software applications.

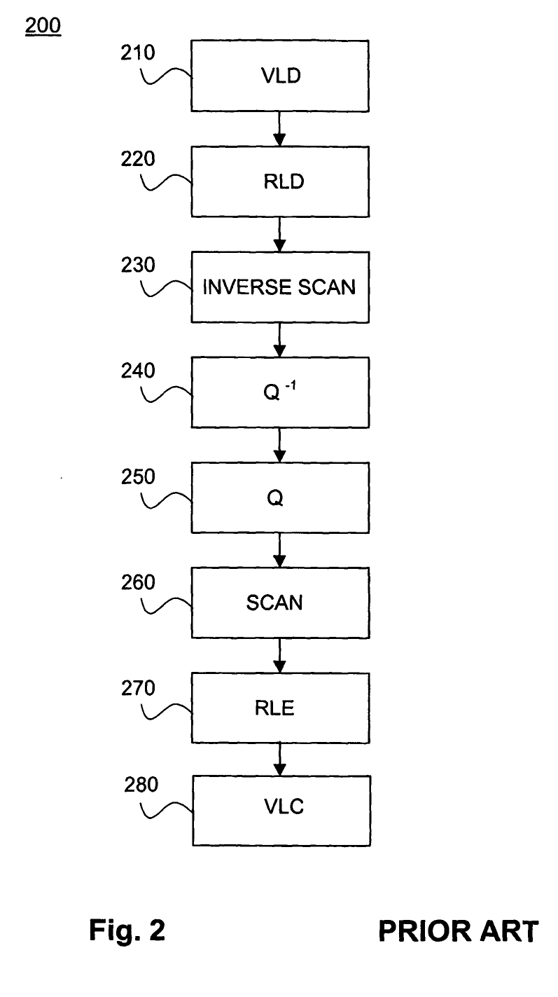

FIG. 2 shows a flow chart of a prior art method for transcoding a JPEG coded bit stream to a MPEG-1 decodable bit stream. The method uses a straightforward cascade structure of a partial JPEG decoder and a partial MPEG-1 decoder operating according to the JPEG standard and MPEG-1 standard, respectively. A JPEG image is Variable Length Decoded (VLD) and Run Length Decoded in step 210 and step 220, respectively. In step 230 an inverse scan is performed and in step 240 reconstructed Discrete Cosine Transform (DCT) coefficients of the JPEG image are derived by means of a JPEG inverse quantization (Q⁻¹). Then, a quantization (Q) and scan is performed for the reconstructed DCT coefficients in step 250 and step 260, respectively. This is follwed by Run Length Coding (RLE) and Variable Length Coding (VLC) in step 270 and step 280, respectively, for receiving an MPEG-1 decodable image.

FIG. 3 shows a general flow chart of the method according to the invention. A JPEG coded image is input to a decoding step 310 where it is decoded so that quantized discrete cosine transform coefficients of a luminance component (Y) and chrominance components (U and V) of the JPEG image are obtained. The decoding is preferably performed according to the JPEG standard.

The quantized discrete cosine transform coefficients of the chrominance components (U and V) of the JPEG image are subjected to a combined JPEG inverse quantization and MPEG quantization in step 320. In step 320 a JPEG chrominance quatization matrix is used for JPEG inverse quantization and a JPEG luminance quantization matrix is used for MPEG quantization for obtaining quantized discrete cosine transform coefficients of the chrominance components (U and V) for an MPEG intra frame having the same chroma format as the JPEG image.

Then, in step 330 the quantized discrete cosine transform coefficients of the luminance component (Y) of the JPEG image and the quantized discrete cosine transform coefficients of the chrominance components (U and V) for the MPEG intra frame are coded for obtaining an MPEG decodable intra frame. The coding is preferably performed according to the MPEG standard.

Hence, by means of this method the inverse scan and scan operation of the prior art method described with reference to FIG. 2 are avoided for both the luminance component (Y) and the chrominance components (U and V). Furthermore, also the inverse quantization and quantization in the prior art method described with reference to FIG. 2 are avoided for the luminance component (Y), and are replaced with the combined JPEG inverse quantization and MPEG quantization of step 320 for the chrominance components (U and V). This reduces the complexity of the transcoding considerably and makes the transcoding faster in relation to prior art methods. This is specifically advantageous in cases where the transcoding is performed in devices which provides low performance for software applications, such as a set top box 120 in FIG. 1. Furthermore, the transcoded image resulting from the method according to the invention, when it is decoded and presented, does not present any observable reduction in image quality.

Thus, with reference to FIG. 1, the invention provides for a fast presentation on a television screen 130 of a JPEG image which is transferred from for example a mobile phone 110 with camera functionality to a set top box 120 in which the JPEG image is transcoded to a MPEG intra frame and then decoded for presentation on the television screen 130. In the decoding of the transcoded MPEG intra frame alternate_scan equal to 0 is selected for MPEG-2 to select zig-zag scanning pattern.

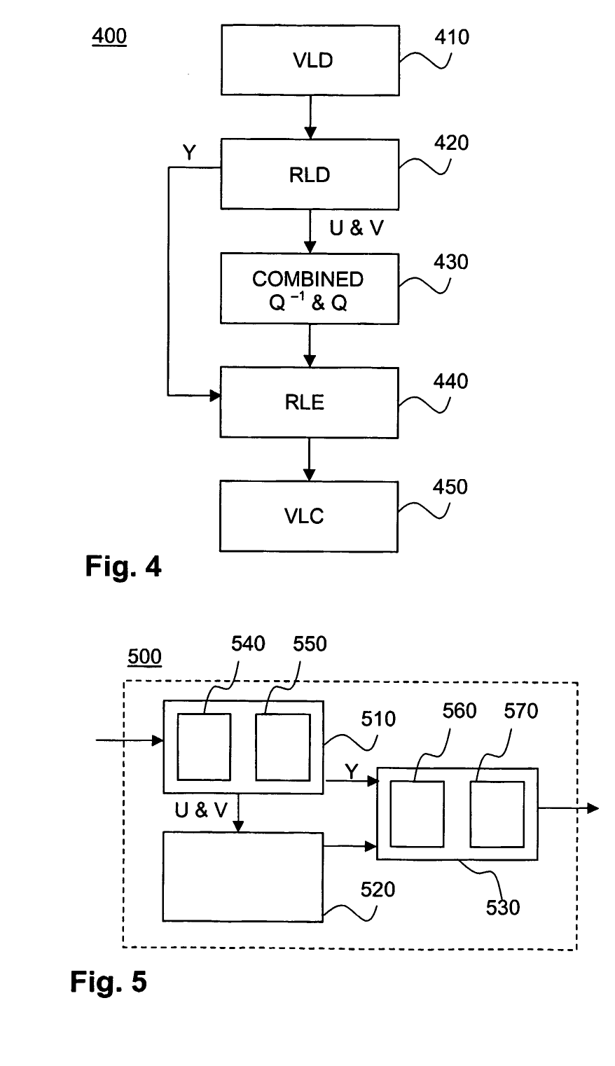

FIG. 4 shows a flow chart of an embodiment of the method according to the invention. A JPEG coded image is Variable Length Decoded (VLD) and Run Length Decoded (RLD) in step 410 and step 420, respectively, to obtain quantized discrete cosine transform coefficients of a luminance component (Y) and chrominance components (U and V) of the JPEG image. VLD and RLD for JPEG is known within the art.

The quantized discrete cosine transform coefficients of the chrominance components (U and V) of the JPEG image are subjected to a combined JPEG inverse quantization and MPEG quantization in step 430.

In the following an equation is derived for obtaining quantized discrete cosine transform coefficients of the chrominance components (U and V) for an MPEG intra frame from the quantized discrete cosine transform coefficients of the chrominance components (U and V) of the JPEG image in the case where the MPEG-2 intra frame has the same chroma format as the JPEG image.

When transcoding the chrominance (U and V) components of an image according to the embodiment for the MPEG-2 case, the following three operations are performed during the transcoding process:
1) Q⁻¹ⱼ, i.e., the JPEG inverse quantization operation,
2) Qₘ, i.e, the MPEG-2 quantization operation, and
3) Q⁻¹ₘ, i.e., the MPEG-2 inverse quantization operation
   A single, low complexity operation is designed that combines Q⁻¹ⱼ and Qₘ. Thus, the MPEG-2 quantization operation Qₘ needs to be defined. As usual in video coding standards, the quantization is not defined in the actual MPEG-2 standard, while the inverse quantization is defined. More importantly, for low complexity transcoders, designing a quantization operation is different from that of high complexity encoders. The special case of processing the intra DC coefficient, i.e., the first coefficient in a 8×8 block, is done as specified in JPEG and MPEG-2 standards. In the following, the dominant case of processing the AC coefficients, i.e., the 63 other coefficients in a 8×8 block is described.

For JPEG, the inverse quantization, denoted Q⁻¹ⱼ, is defined as:
Fⱼ=QFⱼ*Wⱼ,
where
Fⱼ denotes an inverse quantized, i.e., reconstructed DCT coefficient, QFⱼ denotes a quantized DCT coefficient, and Wⱼ denotes an element in the quantization matrix. For notational convenience, the element index is omitted herein.

In JPEG, it is possible (and common) to use two matrixes, one for the luminance and the other for the chrominance components.

Based on Q⁻¹ⱼ, the formula for the quantized DCT coefficients is
QFⱼ=Fⱼ/Wⱼ.
For MPEG-2, the inverse quantization, denoted Q⁻¹ₘ, is defined as
Fₘ=((2*QFₘ+k)*Wₘ[w]*q_scale)/32,
where
Fₘ denotes an inverse quantized, i.e., reconstructed DCT coefficient, QFₘ denotes a quantized DCT coefficient, k=0 for intra blocks, w=0 for intra blocks and for Y, U, and V components, when YUV 4:2:0 is used, Wₘ[w] denotes an element in the quantization matrix, and q_scale denotes the quantization scale factor.

When taking into account that k=0 and Wₘ[0]=Wₘ (simpler notation), Q⁻¹ₘ can be written as
Fₘ=(2*QFₘ*Wₘ*q_scale)/32,
that is equivalent to
QFₘ=32*Fₘ/(2*Wₘ*q_scale)<=>QFₘ=16*Fₘ/(Wₘ*q_scale).

Due to integer division, i.e., division by truncation, we must assume that q_scale=16 for this equivalence to hold. However, as shown below, it is reasonable to select q_scale=16.

For transcoding purposes, it is reasonable to define
Wₘ=Wⱼ,
so that we can re-use the quantization matrix of JPEG. Thus, we obtain
QFₘ=16*Fₘ/(Wⱼ*q_scale).

The key issue in transcoding is to re-use the quantized DCT coefficients, i.e.,
QFₘ=QFⱼ.

Thus, to obtain QFₘ=QFⱼ we can re-use the reconstructed DCT coefficients, i.e., Fₘ=Fⱼ, and select q_scale=16=>
QFₘ=16*Fⱼ/(Wⱼ*16)<=>QFₘ=Fⱼ/Wⱼ.

Thus, we have now obtained QFₘ=QFⱼ.

In MPEG-2, there are two options to obtain q_scale=16 by setting the two parameters of interest as follows q_scale_type=0 and quantizer_scale_code=8, or q_scale_type=1 and quantizer_scale_code=12. In contrast to JPEG, MPEG-2 provides no possibility to use separate quantization matrixes for the luminance and chrominance components, when using the YUV 4:2:0 format. In other words, there can be only one quantization matrix in the MPEG-2 bit stream, and it is used for both the luminance and chrominance components. Thus, the luminance quantization matrix of JPEG, denoted Wⱼ[0] is used for quantization of the chrominance components. Experimental results show that no loss of image quality can be observed when using this approach.

However, inverse quantization uses the chrominance matrix of JPEG, denoted Wⱼ[1] as follows
Fⱼ=QFⱼ*Wⱼ[1].

Thus, the final, combined quantization and inverse quantization equation, is
QFₘ=(QFⱼ*Wⱼ[1])/Wⱼ[0]<=>QFₘ=QFⱼ*(Wⱼ[1]/Wⱼ[0])

For efficient implementation of QFₘ, Wⱼ[1]/Wⱼ[0] can be computed (in fixed-point number representation) into a look-up table before the actual time-consuming kernel loops. This way it is possible to avoid any division operations during the frequently executed kernel loops.

Thus each of the quantized discrete cosine transform coefficients of chrominance components for an MPEG-2 intra frame is derived as the multiplication of a corresponding discrete cosine transform coefficient of the chrominance components of the JPEG image with a quotient between a corresponding element in a JPEG chrominance quantization matrix and a corresponding element in a JPEG luminance quantization matrix.

The combined quantization and inverse quantization equation is valid also for the case where an MPEG-4 intra frame is the output of the embodiment of the method according to the invention. The only difference in this case is that the denominator of the definition of the inverse quantization in MPEG-4 is 16 instead of 32 as for the MPEG-2 case. Thus a quantizer_scale of 8 is selected in MPEG-4 (where a q_scale of 16 was selected for the MPEG-2 case). Furthermore, ac_pred_flag needs to be set to 0 in order to disable the adaptive AC coefficient prediction and to select the zig-zag scan scanning pattern to be used when decoding the MPEG-4 intra frame.

For the MPEG-1 case, the range of the quantized DCT coefficients (QFⱼ) of the JPEG image are checked for each macroblock. If they are in the range [−511, 511] a division by 2 is performed in the combined inverse quantization and quantization. If (−1023≦QFⱼ≦−512 AND 512≦QFⱼ≦1023) a division by 4 is performed in the combined inverse quantization and quantization. The division may be implemented as a shifting operation and is performed in order for the coefficients to fall within the allowed range of MPEG-1, which is [−255, 255]. The scaling may be compensated in the transcoded MPEG-1 frame by multiplying the q_scale parameter by 2 and 4 (i.e. selecting q_scale to be 32 and 64, repectively), in the first and the second case, respectively. There can be a separate q_scale parameter for each macroblock.

Then in step 440 and step 450 the quantized discrete cosine transform coefficients of the luminance component (Y) of the JPEG image and the quantized discrete cosine coefficients of the chrominance components (U and V) for the MPEG intraframe (MPEG-2 or MPEG-4) are Run Length Encoded (RLE) and Variable Length Encoded (VLE) to obtain an MPEG decodable intra frame (MPEG-2 or MPEG-4). RLC and VLC for MPEG-2 and MPEG-4 is known within the art.

FIG. 5 shows a block diagram of an embodiment of the device 500 according to the invention. The device 500 comprises a decoding means 510, a means 520 for combined JPEG inverse quantization and MPEG quantization, and a coding means 530. The decoding means is operatively connected to the means 520 and to the decoding means 530. The means 520 is operatively connected to the decoding means 530. The decoding means 510 is arranged to decode a JPEG image for obtaining quantized discrete cosine transform coefficients of a luminance component and chrominance components of the JPEG image. The decoding means 510 preferably comprises VLD means 540 and RLD means 550 for performing Variable Length Decoding and Run Length Decoding, respectively, in accordance with the JPEG standard. The means 520 is arranged for combined JPEG inverse quantization and MPEG quantization of the quantized discrete cosine transform coefficients of the chrominance components of the JPEG image by means of a JPEG chrominance matrix for JPEG inverse quantization and a JPEG luminance quantization matrix for MPEG quantization. The means 520 preferably derives quantized discrete cosine transform coefficients of chrominance components for an MPEG intra frame having the same chroma format as the JPEG image in accordance with the equation derived in the description with reference to FIG. 4. The coding means 530 is arranged to code the quantized discrete cosine transform coefficients of the luminance component of the JPEG image and the quantized discrete cosine transform coefficients of chrominance components for an MPEG intra frame, for obtaining an MPEG decodable intra frame. The coding means 530 preferably comprises RLC means 560 and VLC means 570 for performing Run Length Coding and Variable Length Coding, respectively, in accordance with the MPEG standard.

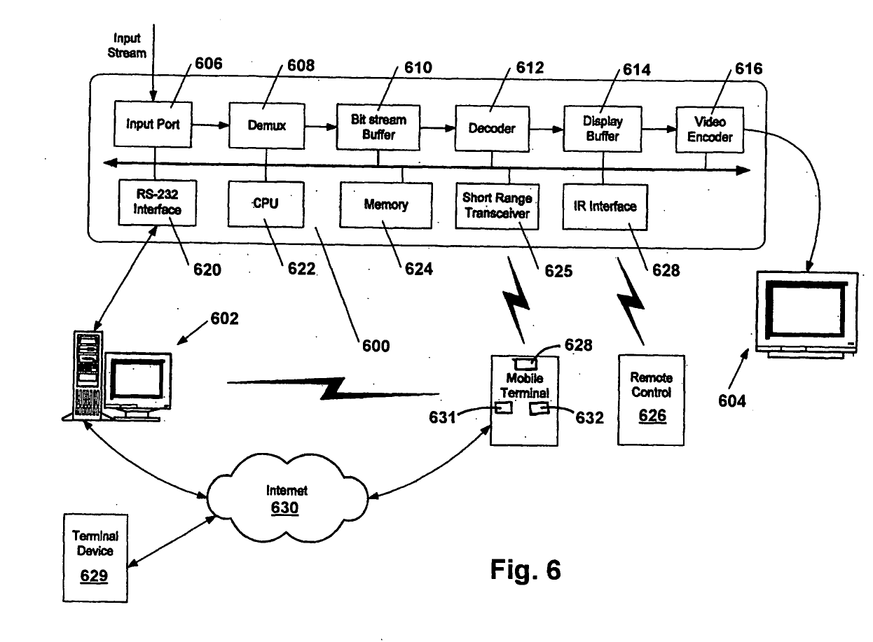

Below a system and methods together with which the invention and embodiments of it may be used are described with reference to FIGS. 6-9.

FIG. 6 shows a block diagram of a system for sending, receiving and displaying digital images. The system comprises the elements 600-630.

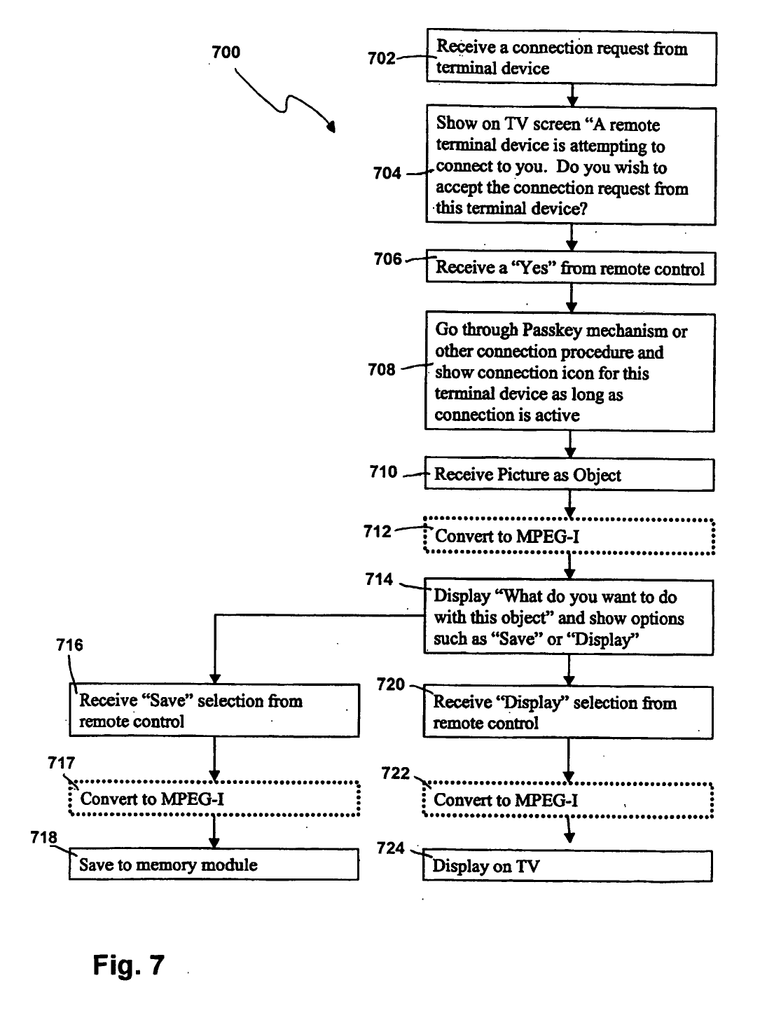

FIG. 7 shows a flow chart of a method for customising the operation of a digital broadcast receiver 600 in FIG. 6. The method 700 comprises the steps 702-724.

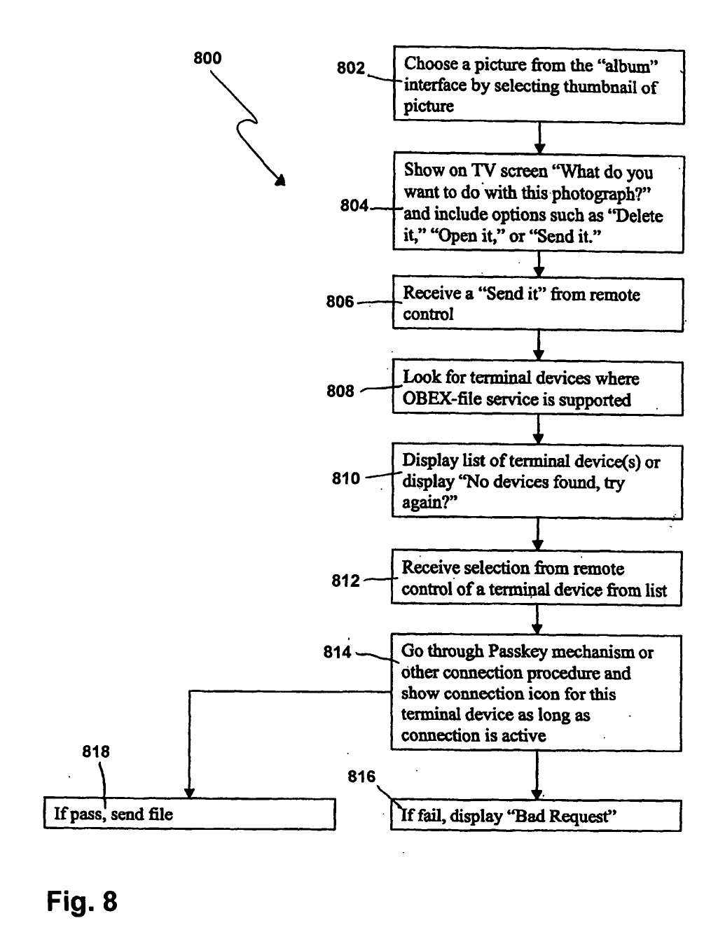

FIG. 8 shows a flow chart of a method for sending a picture stored in the receiver 600. The method 800 comprises the steps 802-818.

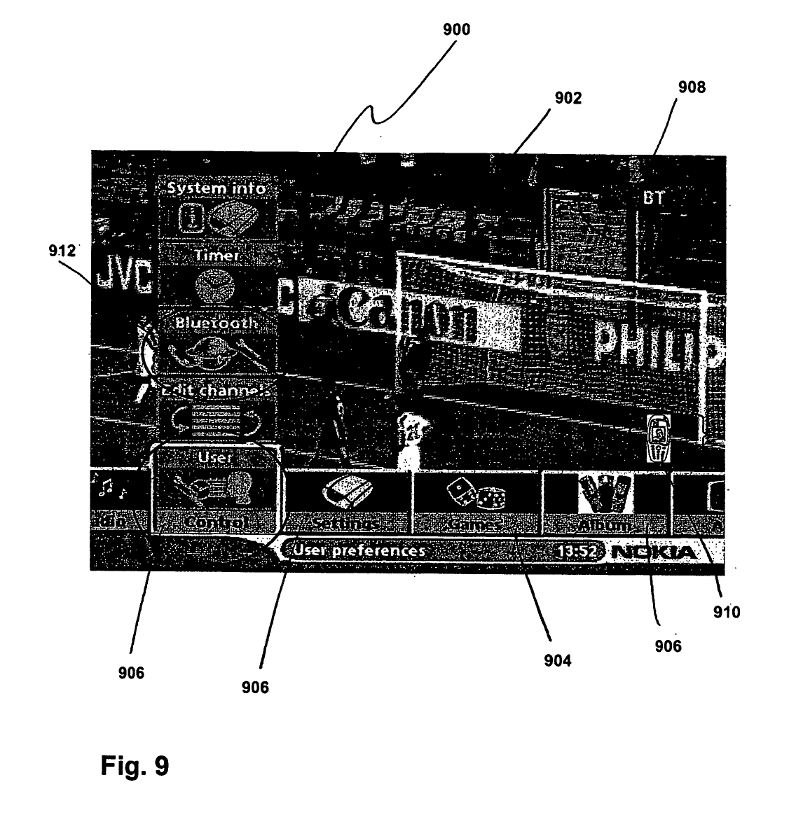

FIG. 9 shows a screen view 900 related to the system shown in FIG. 6 and the methods shown in FIGS. 7 and 8. The screen view comprises the elements 902-910.

The method for customizing the operation of the digital broadcast receiver 600 in accordance with another embodiment of the invention is shown in FIG. 7. In particular, FIG. 7 illustrates a method 700 for uploading an image from a mobile terminal, such as mobile terminal 627. According to method 700, a user of mobile terminal 627 (mobile terminal 627 being, e.g., a digital camera-phone), may desire to send a photograph stored on mobile terminal 627 to receiver 600. As such, if terminal 627 is not connected to receiver 600, it initially sends a connection request that is received in step 702 at receiver 600. In response to receiving the connection request, receiver 600 in step 704 sends a display message to TV 604 to display the text “A remote terminal device is attempting to connect to you. Do you wish to accept the connection request from this terminal device?” or similar text. The name of the device may also be shown. The user may respond using remote control 626, or via direct input to receiver 600. He may also respond via mobile terminal 627 or through other means via computing device 602.

After receiver 600 receives an affirmative response from the user in step 706, it goes through a connection procedure according to the applicable WPAN specification in step 708. In a BLUETOOTH scenario, both terminal 627 and receiver 600 authenticate one another and create a domain of trust. Such authentication may include writing the same passkey to each other, and if the keys match, both terminal 627 and receiver 600 are paired and bonded together. As such, data transferred between these devices may now be encrypted. The passkey mechanism may only be required the first time when an unknown device tries to make a connection to receiver 600.

In accordance with the BLUETOOTH specification, the picture stored on terminal 627 is formatted as an OBEX-file and transferred to receiver 600. The connection with terminal 627 is preferably terminated after the file is transferred. After receiver 600 in step 710 receives the OBEX-file, it may convert the OBEX-file in step 712 to a display format, such as MPEG I-frame. Upon reception of the OBEX-file, in step 314 receiver 600 may send a display message to TV 604 to display the message “What do you want to do with this object?” or similar message. Options are also preferably displayed, such as “Save” and “Display.” If the user selects the “Save” option, when the receiver 600 in step 716 receives the “Save” command, the receiver in step 718 saves the picture in memory module 624. Prior to saving the picture, the OBEX-file may be converted in step 717 to another format, such as MPEG I-frame, if it has not been converted earlier (e.g., in step 712). Alternatively, if the user selects the “Display” option, when the receiver 600 receives such a command, the receiver in step 722 sends instructions to TV 604 to display the picture. It If the OBEX-file for the picture has not previously been converted to a display format, the receiver 600 in step 721 converts the OBEX-file prior to sending display instructions to TV 604.

Referring back to FIG. 8, a method 800 for sending a picture stored in receiver 600 according to an illustrative embodiment is shown. Suppose for example that a user of receiver 600 desires to send a picture stored on the receiver to mobile terminal 627. Suppose also that the mobile terminal 627 is an unknown device to the receiver 600. Suppose further that the picture is stored in an album stored in the receiver 600. The method 800 begins in step 802 when the user selects an album interface by selecting an album icon (e.g., icon 912 in FIG. 5) displayed on TV 604. The album icon may include a thumbnail version of a picture stored in memory module 624. If the album contains more than one image, the user may further select one or more images in the selected album.

In response to receiving the user selection of one or more images, the receiver 600 in step 804 may send instructions to TV 604 to display action options icons and a message such as “What do you want to do with this/these photograph(s)?” requesting an action from the user. The option icons in this scenario may include icons to delete, open, and/or send the image(s). Upon user selection of, for example, a “Send it” icon, receiver 600 in step 806 receives a send message from remote control 626. Because the picture according to the BLUETOOTH specification is sent as an OBEX file, receiver 600 in step 808 looks for terminal devices that support OBEX files. The connection formation is performed according to the principles of Specification Of The Bluetooth System, Volumes 1 and 2, Core and Profiles: Version 1.1 Feb. 22, 2001, which describes the principles of BLUETOOTH device operation and communication protocols. The operation is shortly following: First, the receiver 600 sends Inquiry messages via the short range transceiver 625 and if one or more devices are found, the short range transceiver 625 subsequently sends Paging messages. After receiving one or more Page Responses from the one or more other devices, BLUETOOTH connection can be established and the receiver 600 may ask whether any of the connected devices support Generic Object Exchange Profile (GOEP) and file transfer synchronization using the Object Exchange OBEX Standard. The OBEX standard is specified by the Infrared Association (irDA), Object Exchange Protocol, Version 1.2. The OBEX Standard was adopted by Bluetooth as a binary HTTP protocol that allows multiple request/response exchanges. The queries for GOEP and OBEX support are performed in Bluetooth Service Discovery Protocol (SDP), which defines the investigation of services available to a BLUETOOTH unit from other units. After receiving OBEX-support indications from the one or more other devices, the receiver 600 in step 810 sends a message to display a list of such devices. If no devices supporting OBEX are found, receiver 600 in step 810 sends a message to display the message “No supporting devices found, try again?” or a similar message.

When receiver 600 locates a number of applicable devices (i.e., devices that support OBEX-files) and therefore displays a list of the devices in step 810, the list may show each device according to a nickname given previously. Suppose mobile terminal 627 is on the list and the user selects it in step 812 via remote control 626. Upon reception of the user's selection, receiver 600 and terminal 627 go through authentication mechanisms as described previously including, e.g., using a passkey mechanism. If the authentication fails, receiver 600 in step 816 sends display instructions to display the message “Bad Request.” If authentication is successful, receiver 600 in step 818 sends the OBEX-file for the selected picture to terminal 627. When the transmission is complete, the connection is preferably terminated. While the connection is active, a connection icon (e.g., icon 910 in FIG. 9) is preferably displayed on TV 604.

1. A method for transcoding digital images, comprising: decoding of at least portions of a first image coded according to a first method, for obtaining first coefficients of a luminance component and chrominance components of the first image coded according to the first method; combined inverse quantization according to the first method and quantization according to a second method of the first coefficients of the chrominance components of the first image coded according to the first method, by means of a chrominance quantization matrix of the first method for inverse quantization according to the first method and a luminance quantization matrix of the first method for quantization according to the second method, for obtaining second coefficients of chrominance components of at least portions of a second image according to the second method having the same chroma format as the first image coded according to the first method; and coding of the first coefficients of the luminance component of the at least portions of the first image coded according to the first method and of the second coefficients of the chrominance components of the at least portions of the second image according to the second method, for obtaining at least portions of the second image decodable according to the second method.

2. The method according to claim 1, wherein the combined inverse quantization according to the first method and quantization according to the second method comprises: deriving of each of the second coefficients of chrominance components of the at least portions of the second image according to the second method as the multiplication of a corresponding coefficient of the first coefficients of the chrominance components of the first image coded according to the first method with a quotient between a corresponding element in the chrominance quantization matrix of the first method and a corresponding element in the luminance quantization matrix of the first method.

3. The method according to claim 2, further comprising: providing of a precomputed set of quotients between each element in the chrominance quantization matrix of the first method and a corresponding element in the luminance quantization matrix of the first method.

4. The method according to claim 1, further comprising: decoding of the at least portions of the second image decodable according to the second method.

5. The method according to claim 1, wherein the first image coded according to the first method is an JPEG image, and the second image coded according to the second method is an MPEG intra frame.

6. The method according to claim 5, wherein the first and second coefficients are quantized discrete cosine transform coefficients, the inverse quantization according to the first method is JPEG inverse quantization, the quantization according to the second method is MPEG quantization, the chrominance quantization matrix of the first method is the JPEG chrominance quantization matrix, and the luminance quantization matrix of the first method is the JPEG luminance quantization matrix.

7. The method according to claim 5 [[or 6]], wherein the decoding comprises:
JPEG variable length decoding of the luminance component and the chrominance components of the JPEG image; and
JPEG run length decoding of the JPEG variable length decoded luminance component and chrominance components, for obtaining quantized discrete cosine transform coefficients of a luminance component and chrominance components of the JPEG image.

8. The method according to any one of claim 5 7 claim 5, wherein the coding comprises:
MPEG run length coding of the quantized discrete cosine transform coefficients of the luminance component of the JPEG image and of the quantized discrete cosine transform coefficients of chrominance components of a MPEG intra frame; and
MPEG variable length coding of the result of the MPEG run length coding.

9. The method according to claim 5, wherein MPEG-2 is used.

10. The method according to claim 5, wherein MPEG-4 is used.

11. The method according to claim 5, wherein MPEG-1 is used.

12. The method according to claim 5, wherein the chroma format of the JPEG image and the MPEG intra frame is 4:2:0.

13. A device for transcoding digital images, comprising: a means for decoding of at least portions of a first image coded according to a first method for obtaining first coefficients of a luminance component and chrominance components of the first image coded according to the first method; a means for combined inverse quantization according to the first method and quantization according to a second method of the first coefficients of the chrominance components of the first image coded according to the first method, by means of a chrominance matrix of the first method for inverse quantization according to the first method and a luminance quantization matrix of the first method for quantization according to the second method, for obtaining second coefficients of chrominance components of at least portions of a second image according to the second method having the same chroma format as the first image coded according to the first method, said means being operatively connected to said means for decoding; and a means for coding of the first coefficients of the luminance component of the at least portions of the first image coded according to the first method and of the second coefficients of the chrominance components of at least portions of the second image according to the second method, for obtaining at least portions of the second image decodable according to the second method, said means being operatively connected to said means for combined inverse quantization and quantization and to said means for decoding.

14. The device according to claim 13, wherein the means for combined inverse quantization and quantization is arranged to derive each of the second coefficients of chrominance components of the at least portions of the second image according to the second method as the multiplication of a corresponding coefficient of the first coefficients of the chrominance components of the first image coded according to the first method with the quotient between a corresponding element in the chrominance quantization matrix of the first method and a corresponding element in the luminance quantization matrix of the first method.

15. The device according to claim 14, further comprising: a means for providing of a precomputed set of quotients between each element in the chrominance quantization matrix of the first method and a corresponding element in the luminance quantization matrix of the first method, said means being operatively connected to said means for combined inverse quantization and quantization.

16. The device according to claim 13, further comprising: a means for decoding of the at least portions of the second image decodable according to the second method, said means being operatively connected to said means for coding.

17. The device according to claim 13, wherein the first image coded according to the first method is an JPEG image, the second image coded according to the second method is an MPEG intra frame.

18. The device according to claim 17, wherein the first and second coefficients are quantized discrete cosine transform coefficients, the inverse quantization according to the first method is JPEG inverse quantization, the quantization according to the second method is MPEG quantization, the chrominance quantization matrix of the first method is the JPEG chrominance quantization matrix, and the luminance quantization matrix of the first method I the JPEG luminance quantization matrix.

19. The device according to claim 17 [[or 18]], wherein the means for decoding comprises: a means for JPEG variable length decoding of the luminance component and the chrominance components of the JPEG image; and a means for JPEG run length decoding of the JPEG variable length decoded luminance component and chrominance components, for obtaining quantized discrete cosine transform coefficients of a luminance component and chrominance components of the JPEG image.

20. The method according to claim 17, wherein the means for coding comprises: a means for MPEG run length coding of the quantized discrete cosine transform coefficients of the luminance component of the JPEG image and of the quantized discrete cosine transform coefficients of chrominance components of a MPEG intra frame; and a means for MPEG variable length coding of the result from the means for MPEG run length coding.

21. The device according to claim 17, wherein MPEG-2 is used.

22. The device according to claim 17, wherein MPEG-4 is used.

23. The device according to claim 17, wherein MPEG-1 is used.

24. The device according to claim 17, wherein the chroma format of the JPEG image and the MPEG intra frame is 4:2:0.
